(19) United States
(12) Patent Application Publication
(10) Pub. No.: US 2010/0134558 A1
(43) Pub. Date: Jun. 3, 2010

(54) CARRIAGE AND RECORDING APPARATUS PROVIDED THEREWITH

(75) Inventor: Takayuki SHIOTA, Kitakyushu-shi (JP)

Correspondence Address: Workman Nydegger;1000 Eagle Gate Tower, 60 East South Temple, Salt Lake City, UT, 84111, US

(73) Assignee: SEIKO EPSON CORPORATION, Tokyo (JP)

(21) Appl. No.: 12/623,614

(22) Filed: Nov. 23, 2009

(30) Foreign Application Priority Data
Dec. 1, 2008 (JP) 2008-306386

(51) Int. Cl. B41J 23/00

(52) U.S. Cl. 347/37

(57) ABSTRACT

A carriage mounting a head unit having a recording head thereon and reciprocatably supported on a recording apparatus, the carriage includes: a displacement mechanism displacing the head unit in the direction intersecting with a head surface of the recording head; and a tilt angle adjusting mechanism to adjust a tilt angle of the head unit in a rotation direction along the head surface. The tilt angle adjusting mechanism has a slidably contacting member slidably contacting with the head unit in the case of the displacement of the head unit to define the tilt angle of the head unit, and has an adjusting eccentric cam engaging with the slidably contacting member to adjust the position of the slidably contacting member.

### BACKGROUND

1. Technical Field

The present invention relates to a carriage reciprocatably supported by a recording apparatus, and relates to a recording apparatus provided with the carriage.

2. Related Art

In a recording apparatus such as an ink jet printer, it is one of important elements for achieving high quality of recording to accurately define a distance between the head surface of a recording head and the recording surface of a recording material. This leads to a recording apparatus known with an adjusting mechanism (hereinafter referred to as an “APG adjusting mechanism”) automatically adjusting a gap (so-called a platen gap, hereinafter referred to as a “PG”) between a supporting surface such as a platen supporting the recording material and the head surface of the recording head. The distance between the head surface of the recording head and the recording surface of the recording material is accurately defined by adjusting the PG, depending on a kind and thickness of the recording material regardless of the various properties of the recording material.

A related APG adjusting mechanism has employed a structure in which a carriage is displaced in a direction intersecting with a head surface by vertically moving whole of a carriage supporting structure such as a carriage guide shaft reciprocatably supporting a carriage, and thereby a PG is adjusted (see, for example, JP-A-10-211748). In recent years, however, a recording apparatus such as an ink jet printer includes a larger recording head in order to achieve higher speed and quality, leading to a tendency that a carriage becomes larger and heavier. Therefore, in the related APG adjusting mechanism vertically moving the carriage and whole of the carriage supporting structure, total weight of the whole carriage including a head unit and the carriage guide shaft needs to be supported with enough rigidity, and they also need to be accurately moved in vertical, unavoidably resulting in whole of the mechanism to be large-scale. In other words, the APG adjusting mechanism vertically moving whole of the carriage supporting structure has disadvantages to cause a larger recording apparatus and significantly higher cost due to the larger recording head.

A recording apparatus provided with an APG adjusting mechanism in a carriage is known as an example of a related art which can solve these problems (see, for example, JP-A-2004-268340). This carriage has a two-piece structure including a main carriage and a sub-carriage. A head unit is mounted on the sub-carriage supported by the main carriage under a floating condition. A mechanism adjusting a PG by displacing the sub-carriage in a direction intersecting with a head surface is provided in the carriage. The disadvantage of a larger recording apparatus and significantly higher cost, which described above, is reduced by providing the APG adjusting mechanism in the carriage in this way.

In order to achieve highly accurate recording in a recording apparatus such as an ink jet printer, a mechanism to adjust a tilt angle in a rotation direction along the head surface of a recording head (simply referred to a “tilt angle” hereinafter) is necessary in a manufacturing process such that the nozzle line of the recording head is generally orthogonal to a direction in which a carriage reciprocates. Therefore, the carriage disclosed in JP-A-2004-268340 has an adjusting eccentric cam slidablely contacting with the sub-carriage in the main carriage as a mechanism adjusting the tilt angle of the sub-carriage. Specifically, the tilt angle of the sub-carriage may be adjusted by adjusting the rotational position of the adjusting eccentric cam, thereby the tilt angle of the recording head mounted on the sub-carriage may be adjusted (see paragraph 0087, 0088, and FIG. 23 relating to “an eccentric cam 272 for adjusting head angle” in JP-A-2004-268340).

The carriage disclosed in JP-A-2004-268340, however, is displaced in every adjustment of the PG while the sub-carriage slidably contacts with the cam surface of the adjusting eccentric cam, leading to the gradual wear of the cam surface in every adjustment of the PG. In addition, since the cam surface (curved surface) of the adjusting eccentric cam and the side surface (flat surface) of the sub-carriage are in generally line contact with each other due to the shape of a slidably contacting surface, the slidably contacting part of the cam surface of the adjusting eccentric cam is locally worn, resulting in a trouble that the wear has rapidly grown. Consequently, the carriage disclosed in JP-A-2004-268340 has a disadvantage to decrease the accuracy of recording due to a gradual variation in the tilt angle of the recording head caused by the wear of the cam surface of the adjusting eccentric cam.

### SUMMARY

An advantage of some aspects of the invention is to avoid a trouble of decreasing the accuracy of recording due to the gradual variation in a tilt angle of a recording apparatus in which an APG adjusting mechanism and a mechanism to adjust the tilt angle of the recording head are provided.

In order to achieve the advantage, according to an aspect of the invention, a carriage on which a head unit having a recording head is mounted and which is reciprocatably supported by a recording apparatus includes a displacement mechanism and a tilt angle adjusting mechanism, the displacement mechanism displacing the head unit in a direction intersecting with the head surface of the recording head, and the tilt angle adjusting mechanism adjusting the tilt angle of the head unit in a rotation direction along the head surface. The tilt angle adjusting mechanism has a slidably contacting member which slidably contacts with the head unit during the displacement of the head unit and defines the tilt angle of the head unit. The tilt angle adjusting mechanism also has an adjusting eccentric cam to adjust the position of the slidably contacting member through engagement with the slidably contacting member.

The cam surface of the adjusting eccentric cam can be configured so as not to slidably contact with the head unit in direct by interposing the slidably contacting member between the adjusting eccentric cam and the head unit. Thereby, the surface of the adjusting eccentric cam can be prevented from being worn thereof during the displacement of the head unit. In addition, since the slidably contacting member is not limited to a specific form, it can be slidably in surface contact with the head unit. Thereby, frictional force acting on a slidably contacting portion is dispersed on whole of a slidably contacting surface, resulting in significant lessening of the wear of the slidably contacting member during the displacement of the head unit. Consequently, the variation in the tilt angle of the recording head caused by the wear of the slidably contacting member significantly lessens.

The carriage according to an aspect of the invention can take an advantage that the risk of lowering the accuracy of recording due to the gradual variation in the tilt angle of the recording head is avoided in a recording apparatus having a carriage in which an APG adjusting mechanism and a mechanism to adjust the tilt angle of the recording head are provided.

In this case, it is preferable that the slidably contacting member is made from a material having higher wear resistance than that of the adjusting eccentric cam and that the adjusting eccentric cam is made from a material having lower mold shrinkage ratio than that of the slidably contacting member.

In a material used in molding a part by injection molding or the like, since a material having high wear resistance generally does not exhibit dimensional part accuracy due to high mold shrinkage ratio, it is not frequently employed as a material of the adjusting eccentric cam that the part accuracy is required. On the other hand, a material which has low mold shrinkage ratio and can exhibit the part accuracy which is required in the adjusting eccentric cam often has low wear resistance in general. Accordingly, in the material used in molding a part by injection molding or the like, the wear resistance and the part accuracy are often incompatible properties with each other.

Thus, for example, in a structure in which a head unit slidably contacts with the cam surface of the adjusting eccentric cam in direct in a similar way to a related art, it is difficult to reduce the wear of the cam surface of the adjusting eccentric cam by selecting molding material. On the other hand, the adjusting eccentric cam having a high wear resistance can be precisely manufactured from rigid metallic-material or the like, for example. Since such adjusting eccentric cam, however, results in a high-cost product, it is not practical in cost and not employed in a common recording apparatus.

In view of the above problems, it is preferable in the aspect of the invention that a structure interposing the slidably contacting member between the adjusting eccentric cam and the head unit is employed, the slidably contacting member is made from a material having higher wear resistance than that of the adjusting eccentric cam, and the adjusting eccentric cam is made from a material having lower mold shrinkage ratio than that of the slidably contacting member. Thereby, the tilt angle of the recording head can be more accurately adjusted, and the wear of the slidably contacting member can be reduced by lessening the variation in the tilt angle of the recording head caused by the wear of the slidably contacting member. Consequently, the carriage in this case can take an advantage to solve a problem of lowering the accuracy of recording due to the gradual variation in the tilt angle of the recording head.

In the above described carriage, it is preferable that a fixation mechanism to fix the position of the slidably contacting member after adjustment is provided. Since the fixation mechanism can fix the position of the slidably contacting member after the adjustment, the tilt angle of the head unit during the adjustment can be more stably and firmly held.

In the above described carriage, it is preferable that the slidably contacting member is rotatably supported and slidably contacts with the head unit at a portion between a portion with which the adjusting eccentric cam engages and a rotating shaft.

According to the above features, a resolution may be improved in the case of adjusting the tilt angle of the recording head through adjusting the rotational position of the adjusting eccentric cam, depending on a ratio between a length from a portion with which the adjusting eccentric cam is engaged to the rotating shaft and a length from a portion with which the head unit slidably contact to the rotating shaft. Accordingly, the carriage in this case can give an advantage that the tilt angle of the recording head can be more accurately adjusted.

According to another aspect of the invention, a recording apparatus including a carriage having any one of the advantages described above is provided. The recording apparatus can give any one of the advantages described above.

### BRIEF DESCRIPTION OF THE DRAWINGS

The invention will be described with reference to the accompanying drawings, wherein like numbers reference like elements.

FIG. 1 is a main portion perspective view of an ink jet printer.

FIG. 2 is an enlarged main portion perspective view of a portion of an ink jet printer.

FIG. 3 is a main portion side view of an ink jet printer.

FIG. 4 is an enlarged main portion perspective view of a portion of an ink jet printer.

FIG. 5 is a main portion perspective view of a carriage.

FIG. 6 is a main portion plan view of a carriage.

FIG. 7 is a main portion perspective view of a head unit and an APG adjusting mechanism.

FIG. 8 is a main portion side view of a head unit and an APG adjusting mechanism.

FIG. 9 is a main portion perspective view of a head unit.

FIG. 10 is an enlarged plan view of a portion of a head unit.

FIG. 11 is a main portion side view of a carriage.

FIG. 12A and FIG. 12B are perspective views of an adjusting eccentric cam.

### DESCRIPTION OF EXEMPLARY EMBODIMENTS

An embodiment of the invention will now be described with reference to the drawings.

### The Schematic Structure of an Ink Jet Printer

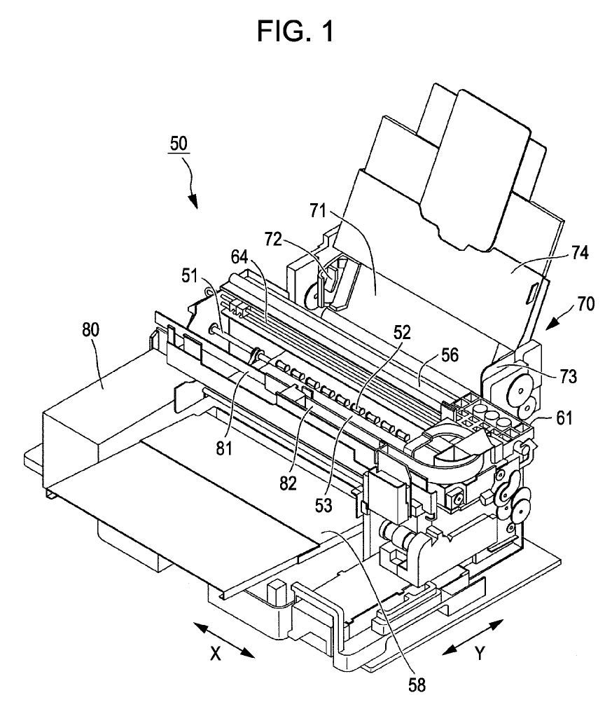

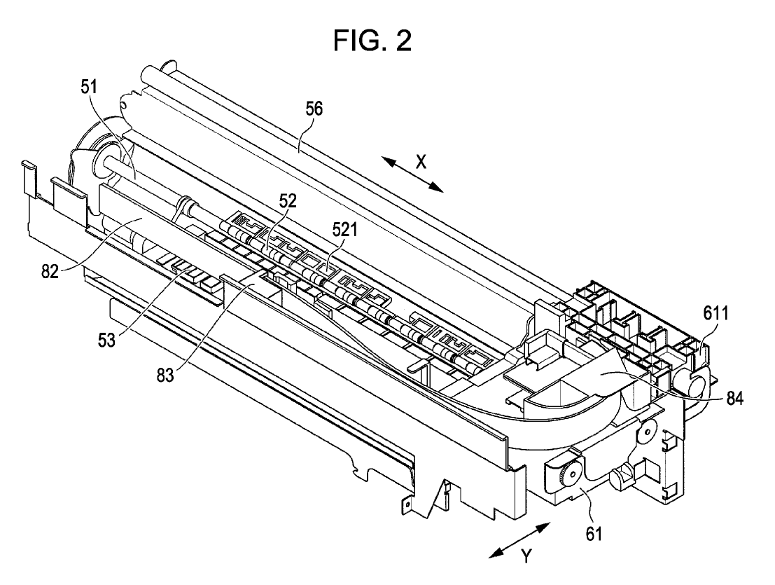

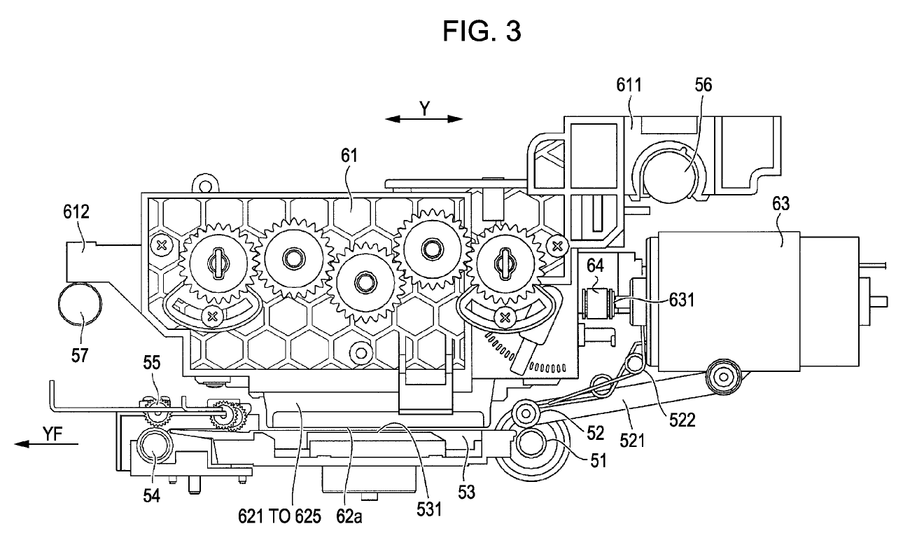

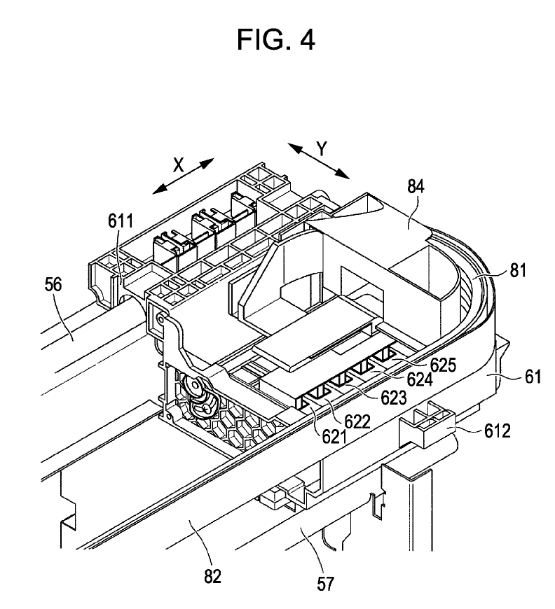

A schematic structure of an ink jet printer 50 as a recording apparatus according to the embodiment of the invention is described with reference to FIGS. 1 to 4. FIG. 1 is a main portion perspective view of the ink jet printer 50, and FIG. 2 is a main portion perspective view which is an enlarged view of a portion thereof. FIG. 3 is a main portion side view of the ink jet printer 50, and FIG. 4 is a main portion perspective view which is an enlarged view of a portion thereof.

The ink jet printer 50 includes an automatic feeding unit 70 which feeds recording paper (not shown) as a recording material to the inside of the ink jet printer 50. The ink jet printer 50 also includes five recording heads 621 to 625 ejecting ink onto the recording surface of the recording paper. The ink jet printer 50 further includes a carriage 61 as a device that allows the recording heads 621 to 625 to scan in a main scanning direction X relative to the recording paper. The ink jet printer 50 further includes a transport driving roller 51, a transport driven roller 52, an ejection driving roller 54, and an ejection driven roller 55 as a device that allows the recording paper to scan in a sub-scanning direction Y relative to the recording heads 621 to 625.

The automatic feeding unit 70 includes a feeding tray 71, a left edge guide 72, a right edge guide 73, a tray cover 74, and a feeding roller (not shown).

The feeding tray 71 is positioned and set with a number of recording paper stacked. The left edge guide 72 and the right edge guide 73 are a guide member which defines the set position of the recording paper stacked on the feeding tray 71 in the main scanning direction X. The tray cover 74 is a lid having a structure of a multiple member slide, in which the upper part of the feeding tray 71 is openable. The top paper of the recording paper stacked on the feeding tray 71 abuts on the outer circumferential surface of the feeding roller and is fed by the rotation of the feeding roller to the position where an end of the paper reaches an abutting portion on the transport driving roller 51 and the transport driven roller 52.

The transport driving roller 51 is applied a high friction coating on its surface and rotates by transferred rotational driving force of a transport motor (not shown). The transport driven roller 52 is rotatably supported by an edge of an oscillatably supported driven-roller holder 521. The driven roller holder 521 is biased by the spring force of a torsion coil spring 522 to a direction in which the transport driven roller 52 abuts on the transport driving roller 51. The recording paper fed from the automatic feeding unit 70 is held between the transport driving roller 51 and the transport driven roller 52, and is transported by the driving rotation of the transport driving roller 51 in sub-scanning direction Y on a platen 53.

The carriage 61 is disposed so as to be reciprocatably in the main scanning direction X while a first bearing 611 is supported by a main guide shaft 56 and a second bearing 612 is supported by a sub-guide shaft 57. In addition, an endless belt 64 hangs between a driving pulley 631 and a driven pulley (not shown) of a carriage driving motor 63 along the main scanning direction X, and a part of the endless belt 64 is connected to a carriage 61. The carriage 61 reciprocates in the main scanning direction X by the bidirectional rotation of the carriage driving motor 63.

The recording heads 621 to 625 are mounted on the carriage 61 such that each head surface 62a of the recording heads faces the supporting surface 531 of the platen 53. In the recording heads 621 to 625, a number of ejection nozzles (not shown) to eject ink are disposed on each head surface 62a. The ink is supplied from an ink tank 80 through an ink tube 81 having five ink flow channels. The driving signals of the recording heads 621 to 625 are outputted from a controller (not shown) having a microcomputer controller through a flexible flat cable (FFC) 82 to a driving circuit substrate (not shown) mounted on the carriage 61. The ink tube 81 and the FFC 82 are made from a material having flexibility so as not to disturb the reciprocation of the carriage 61, and loosely disposed with a certain amount of extra length. The ink tube 81 and the FFC 82 are connected to the carriage 61 by a connecting member 84, and are supported on the case frame of the ink jet printer 50 by a holder member 83 such that the carriage 61 does not oscillate during the reciprocation.

The recording paper on the platen 53 undergoes recording through alternately repeating a movement in which the each of the head surface 62a of the recording heads 621 to 625 ejects ink onto the recording surface to form a dot during the reciprocation of the carriage 61 in the main scanning direction X and a movement in which the recording paper is transported by the driving rotation of the transport driving roller 51 in the sub-scanning direction Y in a predetermined transportation amount. The recording paper after ink ejection is held between the ejection driving roller 54 and the ejection driven roller 55, and transported by the driving rotation of the ejection driving roller 54 in the transport direction YF, finally ejected onto an ejection stacker 58. Such series of recording control is performed by the controller.

### The Structure of a Carriage According to an Embodiment of the Invention

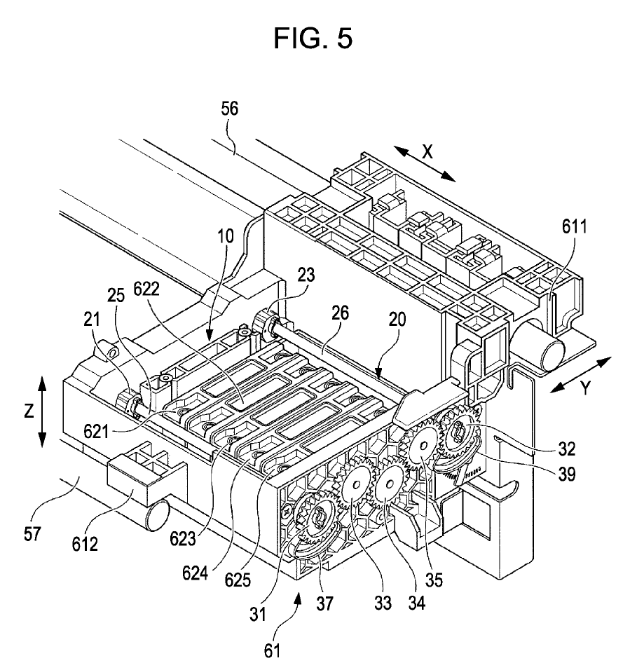

Next, the structure of the carriage 61 is described with reference to FIGS. 5 to 11.

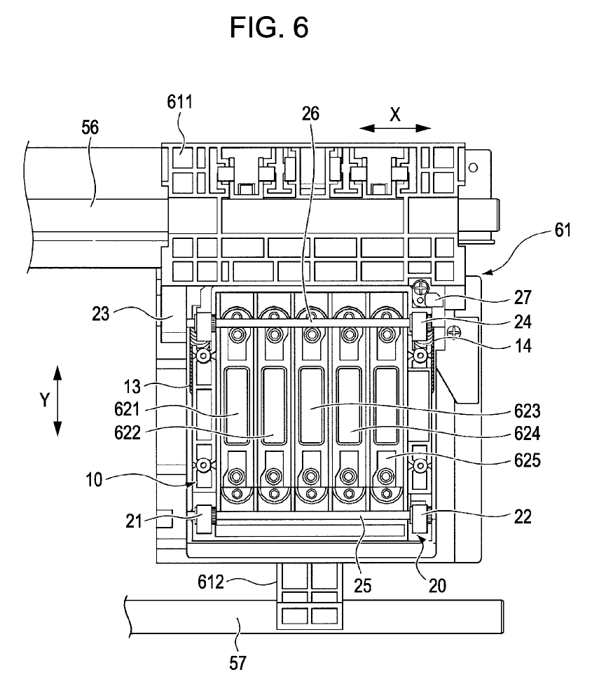

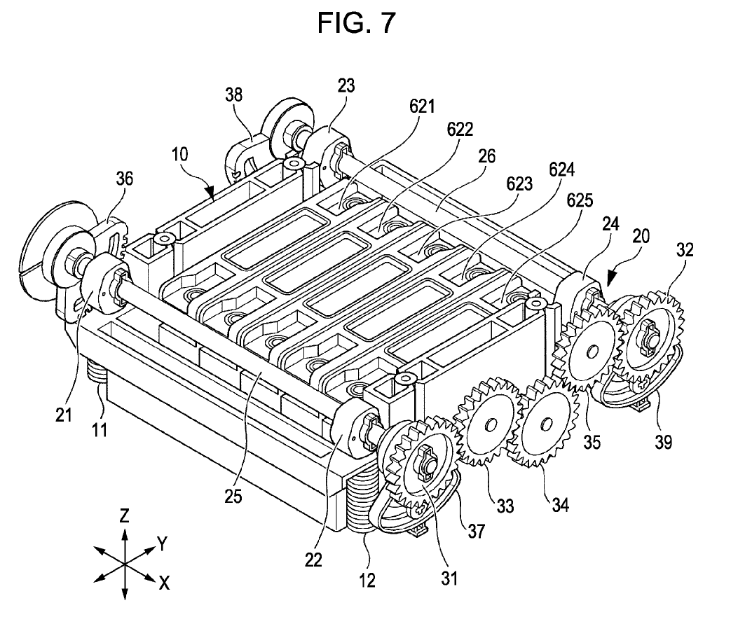

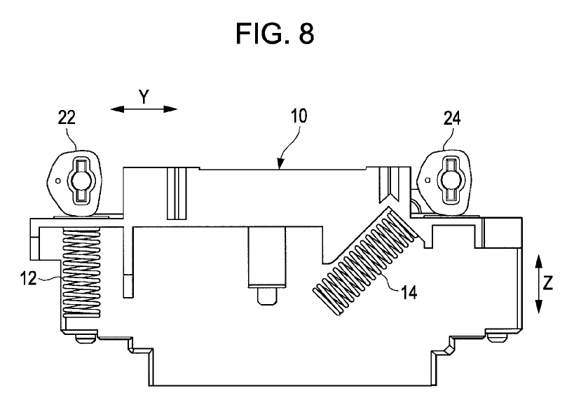

FIG. 5 is a main portion perspective view of the carriage 61. FIG. 6 is a main portion plan view of the carriage 61. FIG. 7 is a main portion perspective view of a head unit 10 and an APG adjusting mechanism 20. FIG. 8 is a main portion side view thereof. A direction intersecting with each head surface 62a of the recording heads 621 to 625 is defined as a Z direction (a direction indicated by symbol Z). A predetermined direction along each head surface 62a of the recording heads 621 to 625 is defined as an X direction (the same direction as the main scanning direction X). A direction along each head surface 62a of the recording heads 621 to 625 intersecting with X direction is defined as a Y direction (the same direction as the sub-scanning direction Y).

The carriage 61 according to the embodiment of the invention includes the head unit 10 and the APG adjusting mechanism 20. The five recording heads 621 to 625 are mounted in parallel on the head unit 10. The APG adjusting mechanism 20 is a displacement mechanism displaceably supporting the head unit 10 in the Z direction and displacing the head unit 10 in the Z direction relative to the carriage 61 by the rotational driving force of a motor to automatically adjust a PG according to thickness or the like of the recording paper.

The APG adjusting mechanism 20 has first to fourth eccentric cams 21 to 24 and four coil springs 11 to 14. The first to fourth eccentric cams 21 to 24 support the head unit 10 in the Z direction. The coil springs 11 to 14 bias the head unit 10 to the first to fourth eccentric cams 21 to 24. More specifically, the first to fourth eccentric cams 21 to 24 are eccentric cams of the same shapes each having the same cam profiles and support the head unit 10 from the upper surface thereof while each of cam surfaces abut on the upper surface of the head unit 10. The four coil springs 11 to 14 are compressedly attached between the head unit 10 and the carriage 61 to bias the head unit 10 to the first to fourth eccentric cams 21 to 24.

The first and second eccentric cams 21 and 22 are eccentric cams of the same shapes which are disposed in phase with a first rotating shaft 25. The first rotating shaft 25 is supported inside the carriage 61. The first and second eccentric cams 21 and 22 support the head unit 10 at one side (downstream side) of the head unit 10 in the Y direction from the recording heads 621 to 625. Furthermore, the first eccentric cam 21 supports the head unit 10 at one side (left side) of the APG adjusting mechanism 20 in the X direction from the recording heads 621 to 625, and the second eccentric cam 22 supports the head unit 10 at the other side (right side) of the APG adjusting mechanism 20 in the X direction from the recording heads 621 to 625.

The third and fourth eccentric cams 23 and 24 are eccentric cams of the same shapes which are disposed in phase with a second rotating shaft 26. The second rotating shaft 26 is supported inside the carriage 61. The third and the fourth eccentric cams 23 and 24 support the head unit 10 at the other end (upstream side) of the head unit 10 in the Y direction from the recording heads 621 to 625. Furthermore, the third eccentric cam 23 supports the head unit 10 at one side (left side) of the APG adjusting mechanism 20 in the X direction from the recording heads 621 to 625, and the fourth eccentric cam 24 supports the head unit 10 at the other side (right side) of the APG adjusting mechanism 20 in the X direction from the recording heads 621 to 625.

The APG adjusting mechanism 20 has a mechanism to displace a supporting surface for the head unit 10 including each cam surface of the first to fourth eccentric cams 21 to 24 in the Z direction relative to the carriage 61. More specifically, gear wheels 31 to 35 are provided in order that the rotational driving force of a motor (not shown) allows the first and second rotating shafts 25 and 26 to rotate in the same rotation direction in the same amount of rotation. The gear wheel 31 is attached to the first rotating shaft 25 such that the rotation thereof can be transmitted, and meshes with the gear wheel 33. The gear wheel 32 is attached to the second rotating shaft 26 such that the rotation thereof can be transmitted, and meshes with the gear wheel 35. The gear wheels 33 to 35 are supported on the outer side surface of the carriage 61. The gear wheels 33 and 35 mesh with the gear wheel 34 each other.

Accordingly, the rotational driving force of the motor can rotate any one of the gear wheels 31 to 35 to rotate the first and the second rotating shafts 25 and 26 in the same rotation direction in the same amount of rotation. Thereby, the head unit 10 can be displaced in the Z direction relative to the carriage 61 to adjust the PG, depending on the cam profiles of the first to fourth eccentric cams 21 to 24. The motor to rotate any one of the gear wheels 31 to 35 may be mounted on the carriage 61, for example. Besides, the motor to rotate any one of the gear wheels 31 to 35 may be disposed on the body of the printer 50, so that a gear wheel rotating by the rotational driving force of the motor mesh with any one of the gear wheels 31 to 35 only when the carriage 61 stops at a predetermined stop position (a home position, for example).

### The Structure of a Tilt Angle Adjusting Mechanism According to an Embodiment of the Invention

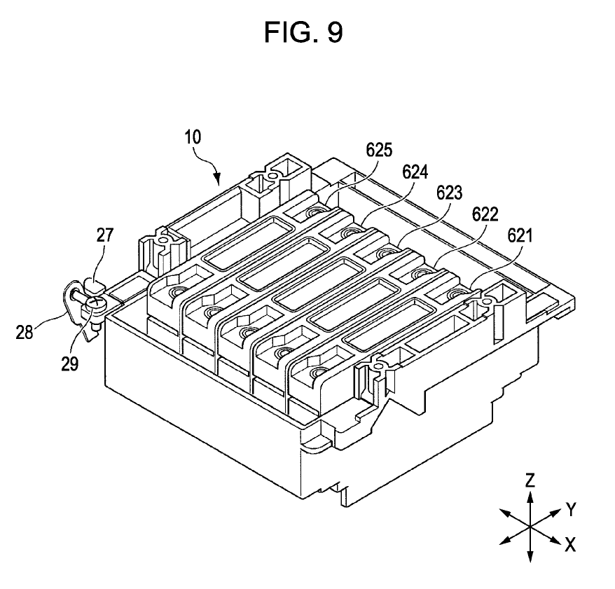

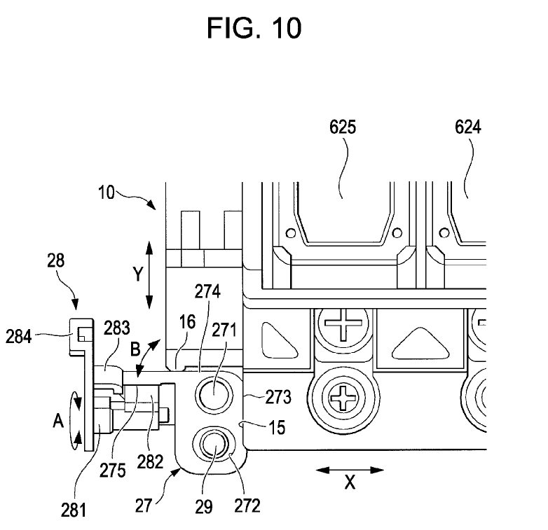

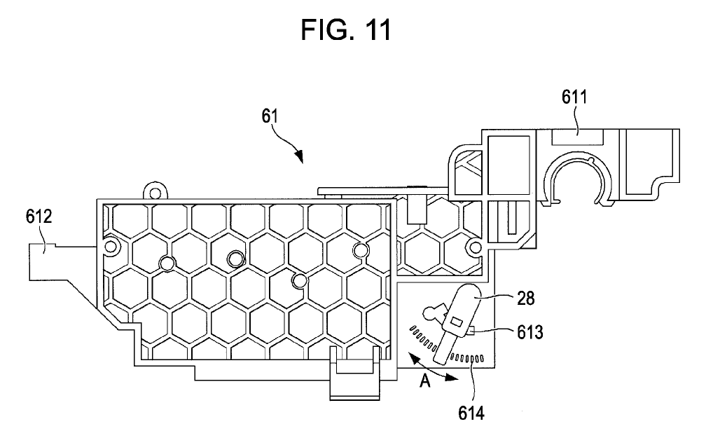

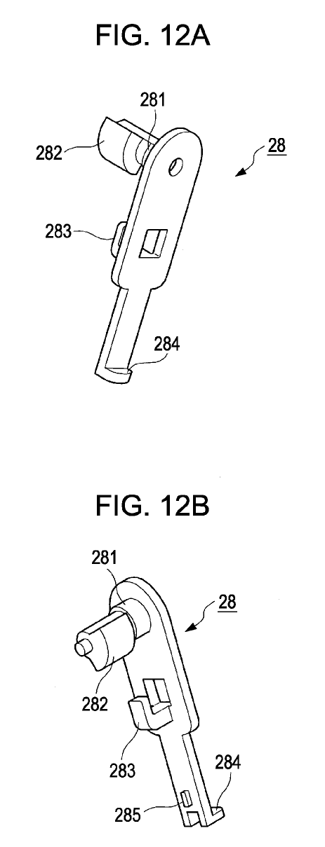

Next, the structure of a tilt angle adjusting mechanism according to the embodiment of the invention is described with reference to FIGS. 9 to 12. FIG. 9 is a main portion perspective view of the head unit 10. FIG. 10 is an enlarged main portion plan view thereof. FIG. 11 is a main portion side view of the carriage 61. FIG. 12 is a perspective view of an adjusting eccentric cam 28.

The carriage 61 according to the embodiment of the invention has a tilt angle adjusting mechanism to position the recording heads 621 to 625 in the main scanning direction X and the sub-scanning direction Y relative to the carriage 61 and adjust a tilt angle (a tilt angle in the Z direction axis) in a rotation direction along each head surface 62a of the recording heads 621 to 625 relative to the carriage 61. The tilt angle adjusting mechanism includes a slidably contacting member 27, the adjusting eccentric cam 28, and a fixation screw 29 as a fixation mechanism.

The slidably contacting member 27 is a member slidably contacting with the head unit 10 in the case of the displacement of the head unit 10 and defining the tilt angle of the head unit 10 in the rotation direction along the head surface 62a. The slidably contacting member 27 is rotatably supported on the carriage 61 by a supporting shaft 271. The head unit 10 is biased to the slidably contacting member 27 by the spring force of an obliquely disposed coil springs 12 and 14. The side surface 15 of the head unit 10 in the X direction abuts on the regulating surface 273 of the slidably contacting member 27 in the X direction. An abutting portion 16 provided on the side surface of the head unit 10 in the Y direction abuts on the regulating surface 274 of the slidably contacting member 27 in the Y direction. Thereby, the recording heads 621 to 625 are positioned in the main scanning direction X and the sub-scanning direction Y relative to the carriage 61.

In addition, a positional relationship in the main scanning direction X between the recording heads 621 to 625 and recording paper may be slightly adjusted by, for example, the adjustment of ejection timing for a transfer position of the carriage 61. Furthermore, a positional relationship in the sub-scanning direction Y between the recording heads 621 to 625 and the recording paper may be slightly adjusted by, for example, adjusting a recording start position in the transport control of the recording paper. Therefore, in a strict sense, the high, relative positional accuracy of the recording heads 621 to 625 is not required in the main scanning direction X and the sub-scanning direction Y relative to the carriage 61.

A tilt angle (a tilt angle in the Z direction axis) in a rotation direction along the head surface 62a of the recording heads 621 to 625 relative to the carriage 61 may be adjusted by adjusting the rotation angle of the slidably contacting member 27. The adjusting eccentric cam 28 is a member to engage with the slidably contacting member 27 to adjust the rotation angle of the slidably contacting member 27. The fixation screw 29 is a screw which screws into a screw hole (not shown) formed on the carriage 61 while it is inserted into the long hole 272 of the slidably contacting member 27 to fix the slidably contacting member 27 after the adjustment.

The adjusting eccentric cam 28 is rotatably supported on the carriage 61 by a rotary shaft portion 281. An eccentric cam portion 282 is integrated with the rotary shaft portion 281. The cum surface of the eccentric cam portion 282 abuts on the cam abutting portion 275 of the slidably contacting member 27. An L-shaped engagement portion 283 engages with a fan-shaped elongated groove formed on the carriage 61. A protrusion 285 engages with any one of recesses 614 formed on the carriage 61 side by side at equal distance to position the rotational position of the adjusting eccentric cam 28. An operator can rotate the adjusting eccentric cam 28 in a direction indicated by a symbol A while the engagement of the protrusion 285 with the recess 614 is released by pulling a knob 284.

The slidably contacting member 27 rotates in a direction indicated by a symbol B through the rotation of the adjusting eccentric cam 28 in the direction indicated by a symbol A. Consequently, the rotational position of the slidably contacting member 27 can be adjusted by adjusting the rotational position of the adjusting eccentric cam 28. In addition, in the slidably contacting member 27, the abutting portion 16 provided on the side surface of the head unit 10 in the Y direction abuts on a portion between the cam abutting portion 275 with which the adjusting eccentric cam 28 is engaged and the rotary shaft portion 281. Consequently, the head unit 10 rotates in an approximately half amount of the displacement relative to that of the cam abutting portion 275 in cases where the slidably contacting member 27 rotates around the rotary shaft portion 281 as a center of the rotation. Thereby, the tilt angle in the rotation direction along each head surface 62a of the recording heads 621 to 625 can be adjusted in approximately double resolution relative to that of the adjusting eccentric cam 28. And after the adjustment, the rotational position of the slidably contacting member 27 can be fixed by fixing the rotational position of the slidably contacting member 27 with the fixation screw 29, thereby the tilt angle in the rotational direction along each head surface 62a of the recording heads 621 to 625 can be stably and firmly held at an appropriate angle.

As described above, interposing the slidably contacting member 27 between the adjusting eccentric cam 28 and the head unit 10 allows the cam surface of the cam portion 282 of the adjusting eccentric cam 28 not to slidably contact with the head unit 10 in direct. Thereby, the cam surface of the cam portion 282 of the adjusting eccentric cam 28 can be prevented from wearing in the case of the displacement of the head unit 10 in the Z direction. Since the slidably contacting member 27 is not limited to a specific form, it can be slidably in surface contact with the head unit 10 as shown in the figure. Thereby, the wear of the slidably contacting member 27 can be extremely lessened in cases where the head unit 10 is displaced in the Z direction, resulting in a significantly small variation in the tilt angle of the recording heads 621 to 625 caused by the wear of the slidably contacting member 27. Consequently, a trouble to lowering the accuracy of recording due to the gradual variation in the tilt angle of the recording heads 621 to 625 can be decreased.

In addition, in the carriage 61 according to the embodiment of the invention, it is preferable that the slidably contacting member 27 is made from a material having higher wear resistance than that of the adjusting eccentric cam 28, and that the adjusting eccentric cam 28 is made from a material having lower shrinkage ratio than that of the slidably contacting member 27. Thereby, the tilt angle of the recording heads 621 to 625 can be more accurately adjusted, and the variation in the tilt angle of the recording heads 621 to 625 caused by the wear of the slidably contacting member 27 can be more lessened. Preferably, a material of the slidably contacting member 27 includes, for example, a wear resistant material such as a polyacetal (POM) resin and a metallic material. On the other hand, a material of the adjusting eccentric cam 28 preferably includes a material having lower mold shrinkage ratio such as an acrylonitrile-butadiene-styrene (ABS) resin, a polyarylate resin, and a modified polyphenylene ether (PPE) resin.

The invention is not limited to the above described embodiments and can be modified within the scope of the appended claims. Such modifications are also obviously contained within the range of the invention.

What is claimed is:

1. A carriage mounting a head unit having a recording head thereon and reciprocatably supported by a recording apparatus, the carriage comprising:
a displacement mechanism displacing the head unit in the direction intersecting with a head surface of the recording head; and
a tilt angle adjusting mechanism to adjust the tilt angle of the head unit in a rotation direction along the head surface,
wherein the tilt angle adjusting mechanism has a slidably contacting member slidably contacting with the head unit in the case of the displacement of the head unit to define the tilt angle of the head unit, and has an adjusting eccentric cam engaging with the slidably contacting member to adjust the position of the slidably contacting member.

2. The carriage according to claim 1, wherein the slidably contacting member is made from a material having higher wear resistance than that of the adjusting eccentric cam, and the adjusting eccentric cam is made from a material having lower mold shrinkage ratio than that of the slidably contacting member.

3. The carriage according to claim 1, further comprising a fixation mechanism to fix the position of the slidably contacting member after adjustment.

4. The carriage according to claim 1, wherein the slidably contacting member is rotatably supported and slidably contacts with the head unit at the portion between a portion with which the adjusting eccentric cam is engaged and a rotating shaft.

5. A recording apparatus comprising the carriage according to claim 1.
